(19) United States
(12) Patent Application Publication
(10) Pub. No.: US 2003/0015188 A1
(43) Pub. Date: Jan. 23, 2003

(54) Temperature-controlled charcoal grill and method therefor

(76) Inventor: Lawrence Harbin, Alexandria, VA (US)

Correspondence Address: LAWRENCE HARBIN, 2906 MAPLEWOOD PLACE, ALEXANDRIA, VA, 22302, US

(21) Appl. No.: 09/909,789

(22) Filed: Jul. 23, 2001

(51) Int. Cl. A47J 37/00; F24B 3/00

(52) U.S. Cl. 126/25 R; 126/21 R; 126/21 A

(57) ABSTRACT

A temperature-controlled charcoal barbecue grill comprises a housing, a charcoal-fired chamber, a cooking region, a cover or lid substantially enclosing the cooking region and charcoal-fired chamber, and a temperature control module that controls temperature in the cooking region using either a mechanical shutter to control radiant energy exposure or an arrangement of fans to displace or circulate air. Preferably, the grill includes a power converter that converts heat to electrical energy to power the control module and associated accessories such as a series of vent fans that supply and exhaust the cooking region, a charcoal blower fan to help oxidize burning charcoal, and an internal circulation fan to help maintain an even temperature distribution within the cooking region. Audible and visual indicators may also indicate various predetermined conditions during operation and control cycles of the grill. Corresponding methods of control are also disclosed.

### BACKGROUND

The present invention relates to charcoal barbecue grills, but more specifically, to controlling cooking temperature in a charcoal or wood-burning grill.

Unlike gas-fired and electric grills, controlling internal cooking temperatures of charcoal or wood-fired grills is difficult or requires complicated mechanisms. Temperature control is desired to permit constant-temperature baking or roasting, to reduce food charring, or to minimize the amount of time required to attend cooking. Due to a chimney effect achieved with vertical hearth grills, briquettes burn hotter, steady, and more efficiently, thus outputting extreme amounts of heat. Thus, it is desired to provide a way to control excess heat and reduce charring of meats. In conventional charcoal grills, temperature control was achieved by regulating air vents in the firebox, but this was often ineffective in view of other factors affecting charcoal burn rates, such as grease and liquid runoffs. Such runoffs frequently extinguished the coals or flamed-up, thus adversely impacting internal temperatures.

U.S. Pat. No. 6,230,700 to Daniels, et al. addresses internal temperature control by providing air circulation within a cooking chamber to disperse heat evenly within its cooking region, but does not adequately control internal cooking temperature in accordance with a temperature feedback sensor/detector or adjustment of amount of heat emanating from the heat source.

In view of the deficiencies of prior charcoal-fired barbecue grills, a feature of the present invention provides control of internal cooking temperature or radiant energy exposure by controlling ingress and/or egress of air with a cooking region and/or by controlling the amount of radiant or convection heat from the firebox that reaches the cooking region. This and other features are achieved electronically and mechanically.

### SUMMARY OF THE INVENTION

In accordance with one aspect of the present invention, a temperature-controlled charcoal or wood-burning barbecue grill comprises a housing, a charcoal-fired chamber, a cooking region, a cover or lid that engages the housing to substantially enclose the cooking region and charcoal-fired chamber with the housing, and a temperature control module that controls the amount of heat supplied to the cooking region. In one particular embodiment, the charcoal grill additionally includes a power converter that converts heat to electrical energy in order to power the control module and associated accessories that may include a series of controllable vent fans that supply and exhaust the cooking region, a controllable charcoal blower fan to help oxidize burning charcoal, and an internal circulatory fan to help maintain an even temperature distribution within the cooking region. Audible and visual indicators may also be included to indicate various predetermined conditions during the operation and control cycles of the grill.

In accordance with another aspect of the present invention, a method of controlling cooking temperature in a charcoal-burning barbecue grill comprises providing a charcoal-fired chamber and a cooking region, substantially enclosing the cooking region and charcoal-fired chamber within the housing, sensing at least one of temperature of the cooking region and energy radiated from the charcoal-fired chamber, deriving power from said charcoal-fired chamber, and using power derived from said charcoal-fired chamber to control the amount of heat of the cooking region either by mechanically adjusting a shutter to control the amount of energy reaching the cooking region or by generating a flow of air communicating with the cooking region or the charcoal-fired chamber. Electrical power may be derived from a thermoelectric power converter while mechanical power may be derived in a variety of ways including use of a bimetallic actuator or other thermo-mechanical device.

Other features and aspects of the invention will become apparent upon review of the following disclosure taken in conjunction with the accompanying drawings. The invention, though, is pointed out with particularity by the appended claims.

### BRIEF DESCRIPTION OF THE DRAWINGS

FIG. 1 shows a side view of a vertical hearth barbecue grill in which aspects of the invention may be deployed.

FIGS. 2A and 2B show perspective and side views of an enclosed cooking region of the vertical hearth barbecue grill of FIG. 1, and further depict a series of microprocessor controllable venting fans in accordance with one aspect of the present invention

FIGS. 3A and 3B show front and rear perspective views of a control module depicted in FIGS. 2A and 2B, which module embodies control electronics, sensors, and indicators in accordance with an aspect of the present invention.

FIG. 4 is a functional block diagram of a circuit for implementing temperature control functions according to one embodiment of the present invention.

FIG. 5 is a flow chart depicting one method of performing temperature control functions according to one embodiment of the present invention.

FIG. 6 is a flow chart depicting another method of performing temperature control functions according to another embodiment of the present invention.

FIG. 7 depicts a mechanically controllable shutter and control mechanism used in conjunction with a vertical firebox hearth of a vertical barbecue grill for maintaining temperature control according to yet another embodiment of the present invention.

FIG. 8 shows deployment of a temperature control module on a cover or lid of the barbecue grill depicted in FIG. 1.

### DESCRIPTION OF ILLUSTRATIVE EMBODIMENTS

According to the invention, temperature in a cooking region of a charcoal or wood-fired grill is controlled by regulating airflow with the cooking region, by controlling the amount of convection heat and/or radiant energy from the firebox that reaches the cooking region, or by a combination of such regulating and controlling. Similar to prior systems, air circulation in the cooking region can also be maintained to evenly disperse heat within the cooking region. Regulating airflow by supplying ambient air to and exhausting air from the cooking region may be performed with the aid of blowers, or simply by opening and closing vents according to a temperature setting. Controlling the amount of radiant energy or convection heat reaching the cooking region is generally achieved by providing a variable mechanical shutter that varies the exposure of firebox energy to the cooking region or by increasing fuel oxidation using a charcoal blower fan. In addition, the regulating and/or controlling may be achieved electronically, i.e., under microprocessor control, or mechanically by, for example, a thermal sensor such as a bimetallic element. Although illustrated with a vertical hearth barbecue grill, aspects of the invention may be deployed in a conventional barbecue grill where the coals are placed horizontally.

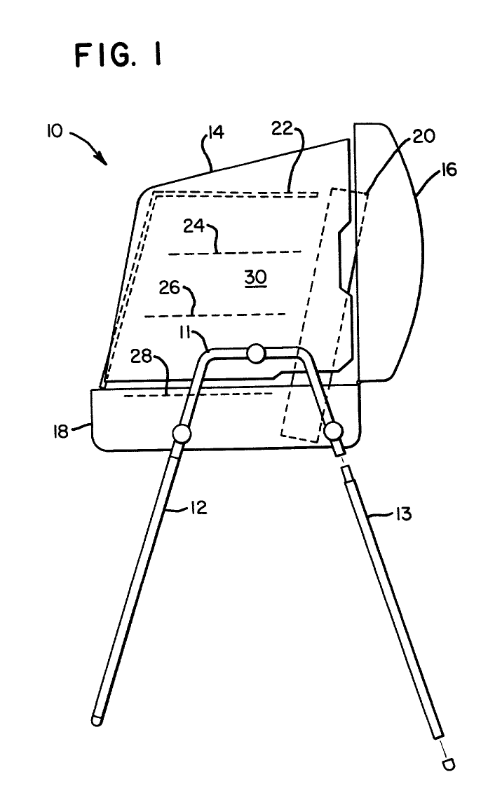

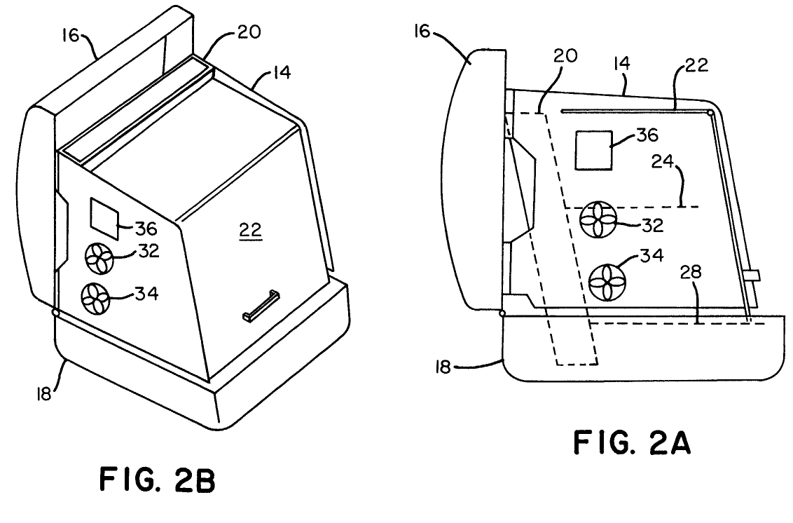

FIG. 1 shows a vertical hearth barbecue grill 10 where deployment of the invention is particularly suited. Grill 10 has a housing generally formed by a base 18, a dome or lid 16, and sidewalls 14 (only one indicated). The exemplary grill is supported by sidebars 11 (only one indicated) as well as leg extensions 12 and 13. A generally vertically disposed firebox hearth 20 inside the grill 10, which is preferably backwardly inclined, supplies radiant and convection heat to a cooking region 30 in front of the firebox hearth 20 and enclosed by a cover 22 (also depicted in FIG. 2). Cover 22 substantially forms an enclosure with the grill housing by mating with the sidewalls 14 and base 18. Multiple cooking grids 24, 26, and 28 support foodstuff within cooking region 30. In a conventional horizontal barbecue grill, cooking region 30 generally lies above a firebox chamber located near the bottom of a base, and a dome or lid mates with the base to form an enclosure.

In accordance with an aspect of the invention, cooking temperature within region 30 is adequately regulated or controlled according to the output of a temperature sensor or detector despite uncontrollable burn rates of charcoal or wood fuels. A first embodiment shown in FIGS. 2A and 2B includes one or more exhaust or vent fans 32 and 34 controlled by a processor module 36 in accordance with an output signal of a sensor or detector 42 exposed to cooking region 30. Fans 32 and 34 establish an ambient air path in communication with cooking region 30, and preferably comprise readily available microprocessor cooling fans or the like that are adapted to withstand temperatures on the order 200-300° C. or more. Any number of commercially available cooling fans may be used, and such fans may be arranged in push-pull arrangement where one sidewall 14 intakes ambient air and the opposed sidewall exhausts air from region 30. Alternatively, air intakes and exhaust ports of the cooking region 30 may be respectively located at upper and lower positions of a single sidewall 14 in order to displace hot air inside the cooking region 30 with cooler ambient air external of region 30. Because the substantially enclosed cooking region 30 of vertical barbecue grill 10 is not airtight, fans 34 and 34 need only exhaust or supply air to effectively establish air flow with the ambient environment in order to maintain a temperature setpoint. As earlier indicated, internal circulation to maintain even temperature dispersion can be achieve in a manner similar to prior systems, i.e., disposing a circulatory fan inside the region 30.

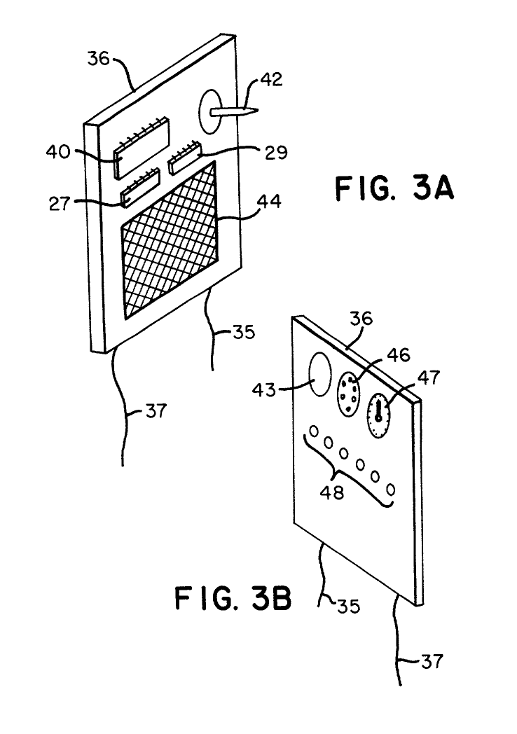

FIGS. 3A and 3B show one form of a microprocessor module 36 that provides electronic temperature control within cooking region 30. Module 36 includes, among other things, a microprocessor 40, boot ROM 27, a probe 42 supported on base 43, an optional tone generator or speaker 46, a thermostat 47, an series of LEDs 48 (optional) to visually indicate a pre-designated condition, and a thermoelectric converter 44 all of which may be mounted on a printed circuit (PC) board and encased in a module casing attached to sidewall 14. The PC board may further include analog-to-digital and digital-to-analog and other circuitry embedded within an integrated circuit 29, which may be needed to perform sampling and control functions. Preferably, module 36 attaches to sidewall 14, which has a window that enables exposure of a power converter 44 directly to the heated cooking region, or the exposure of converter 44 directly to a radiant energy path of firebox hearth 20 in order to effectively convert waste heat to electrical power. Probe 42 is a sensor or detector that may protrude through sidewall 14 into the area of the cooking region 30, and that provides an input to microprocessor 40. Sensor 42 may comprise a thermocouple, bimetallic element, heat sensor, IR (infrared) sensor, or other device known in the art to detect or sense heat or radiant energy. Instead of being probe-like, sensor 42 may have a low profile that substantially parallels the inner surface of sidewall 14.

Thermoelectric converter 44 is a semiconductor device that converts heat or radiant energy to electrical electricity for supplying power to microprocessor 40, as well as to power other elements, e.g., the fans, speaker, and LEDs of the module 36. Such thermoelectric converters are commercially available from Hi-Z Technology, Inc. of San Diego, Calif. Converter 44 powers exhaust-intake fans 32 and 34 via supply line 37, as well as an optional, internal circulatory fans to maintain even temperature dispersion inside region 30. In a preferred arrangement, the electrical path of converter 44 and the fans share a common chassis ground established by conductive surfaces of module 36 and sidewall 14, which are in electrical communication with each other. The source of power may also be derived from a steam-driven mechanism, such as disclosed in U.S. Pat. No. 5,832,811 issued Nov. 10, 1998 to King, which describes a water rotisserie

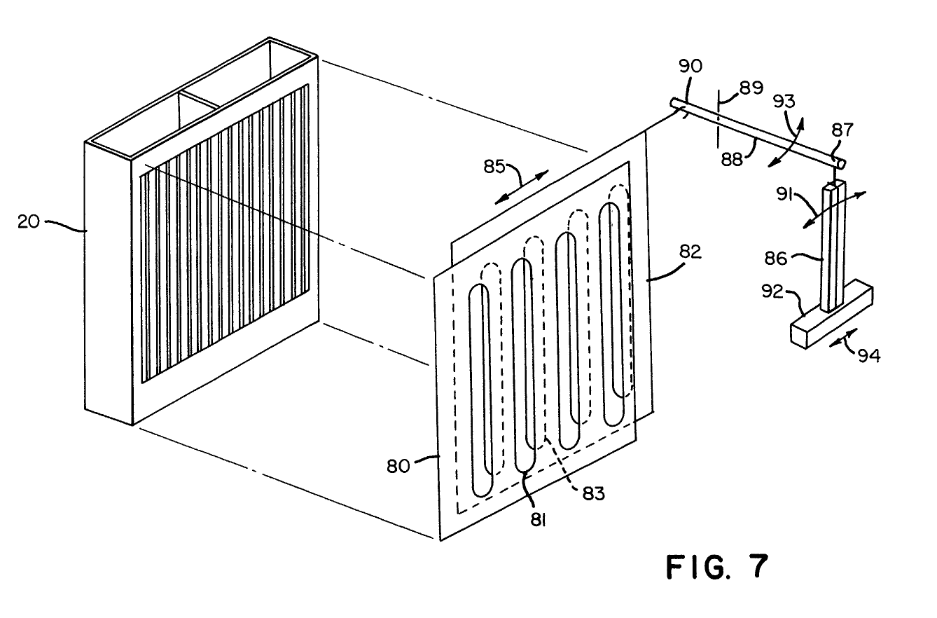

Because temperature control tasks are relatively simple, an eight-bit machine-coded microprocessor 40, such as an Intel 8086 series processor, will suffice to effect sampling of outputs of probe 42, converting that output to a temperature signal, comparing the temperature signal with a setting of thermostat 47, and to turning off and on power to fans 32 and 34 to control or otherwise maintain a constant temperature within cooking region 30 in accordance with a setpoint established by thermostat 47. Executable instructions for carrying out these tasks can be stored in boot ROM 27. Instead of controlling air circulation within and/or with the ambient environment, microprocessor 40 may control a mechanical arm to regulate the amount of radiant energy or convection heat emanating from the firebox hearth 20 as further described in connection with a description of FIG. 7. In addition, rather than controlling airflow within and without cooking region 30, microprocessor 40 may regulate forced air draft supplied directly to the firebox hearth 20 to control bum rate, and consequently, the heat output of the charcoal briquettes or other fuel. Structure to achieve this latter feature entails redirecting airflow, e.g., by using deflecting baffles on blower fans disposed on a sidewall 14, directly upon the fuel source in firebox hearth 20.

An audio annunciator or tone generator 46 may be preprogrammed to audibly indicate a condition, such as successful boot-up of microprocessor 40 or the attainment of a desired temperature inside the cooking region 30. Microprocessor 40 may also be programmed to excite LEDs 48 to indicate these or other desired conditions. The number of LEDs 48 fired may, for example, vary according to level of the internal cooking temperature where a low temperature in region 30 is indicated by a fewer number of fired LEDs and a high temperature is indicated by a higher number of LEDs.

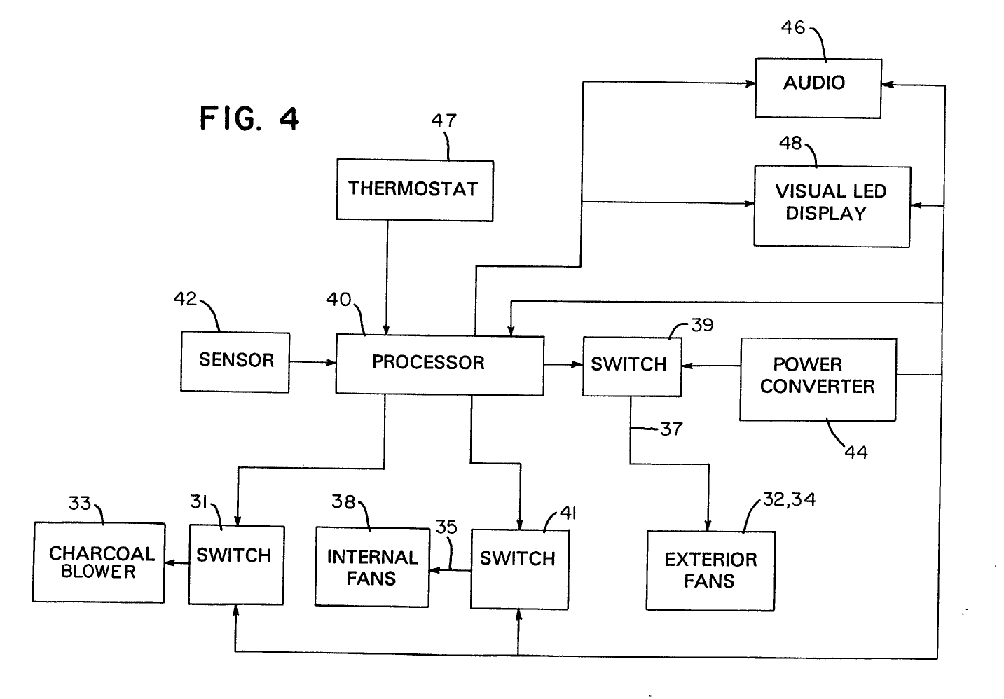

FIG. 4, where like reference numerals depict like elements of FIGS. 3A and 3B, is a functional block diagram of a circuit to implement the temperature control functions according to a preferred embodiment of the present invention. In FIG. 4, power converter 44 powers microprocessor 40. During initial firing up of the grill, power output of converter 44 gradually increases in accordance with thermal output of the coals or other fuel until reaching a threshold operating temperature, at which time microprocessor 40 successfully boots up and performs self-diagnostics. This is typically indicated by an audio beep signal sent by processor 40 to the audio annunciator 46. LEDs may also ignite or flash upon boot up when sufficient power is available to power the fans 32, 34, 33, 38.

After boot up, microprocessor automatically monitors the output of sensor 42 to convert the information to a form useful for comparison with an output or setpoint of thermostat 47. Thermostat 47 is adjusted or set by the user according to a desired cooking temperature to be maintained in cooking region 30, e.g., “high,” “medium,” or “low.” Temperature settings of thermostat 47 may also range between specific temperatures in degrees Celsius (typically 100-250 degrees) and/or Fahrenheit (typically 300-700 degrees). Also, calibration is typically performed before shipment of the grill to the end user so that he or she need not deal with obtaining accurate control.

During an initial stage of operation between say, immediately after boot up, microprocessor 40 activates switch 31 to turn on a charcoal blower fan 33. This expedites initial ignition of the charcoal or other fuel in firebox hearth 20 as fresh air is directed directly upon the fuel source. Due to the extreme heat of the firebox hearth 20 when fully fired, a preferred blower structure includes ducting ambient air using a fan from a relatively cooler location of the grill 10, i.e., the sidewall 14, directly to the face of the firebox. Upon reaching a second threshold temperature, charcoal blower 33 may cease operation whereupon microprocessor 40 trips an optional switch 42 to activate optional internal circulatory fans 38. This is designed to maintain even temperature distribution within the cooking region. At any time during these operations, processor 40 begins to monitor the output of sensor 42 and to implement a routine to compare a representative output of sensor 42 with an output of thermostat 47, as indicated earlier. At a condition where the temperature represented by the output of sensor 42 exceeds the temperature represented by the setting of thermostat 47, microprocessor 40 triggers switch 37 to activate vent fans 32, 34 in order to displace air inside the cooking region 30 with cooler, ambient air. When the internal cooking temperature drops, microprocessor 40 toggles switch 39 to turn off power to fans 32, 34, however, internal circulatory fans 38 maintain their operation to keep even temperature in the cooking region 30.

Generally, with a vertical hearth grill, excess heat is constantly available due to the efficient, study, and hotter burn rates of the coals or other fuel. Exhausting hot air or injecting cooler air is a primary method of achieving temperature control. When the firebox hearth 20 reaches near fuel exhaustion, however, heat and radiant energy output diminishes. To recover additional heat from available fuel remaining in the firebox hearth 20, microprocessor 40 may again activate charcoal blower fan 33 by firing transistor 31. This helps the remaining fuel to burn hotter, i.e., output more heat, whereupon microprocessor 40 again performs its feedback control function in accordance with a comparison between the outputs of sensor 42 and thermostat 47. The foregoing sequence continues to keep the temperature in region 30 adjusted to the level established by the setpoint of thermostat 47. Attainment or passage of each stage may be evidenced by firing any one or a number of LEDs 48, or by issuing an annunciating command to audio output 46. As indicated above, the invention includes a barbecue grill implementing any one of the control features, taken alone or in combination. Switches 31, 41, and 39 preferably comprise power transistor switches.

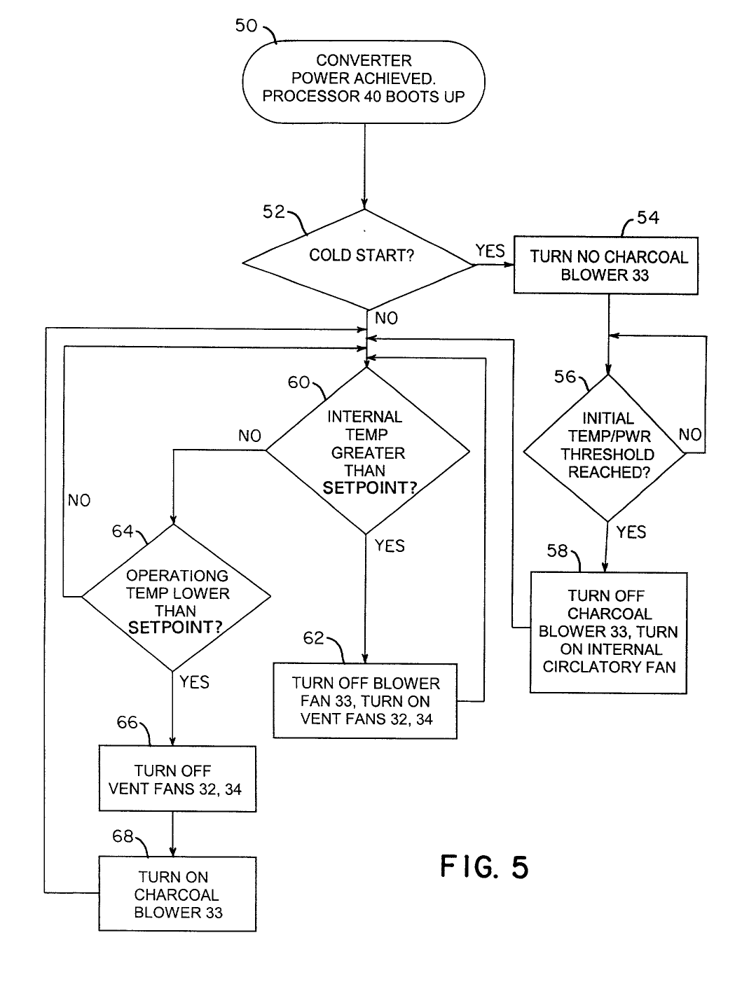

FIG. 5 is a flow chart illustrating one method of carrying out an aspect of the invention. A preferred method of controlling cooking temperature in region 30 of a charcoal barbecue grill having a charcoal-fired chamber and a cooking region defined by substantially enclosing the cooking region and charcoal-fired chamber within the housing comprises sensing the temperature of the cooking region or energy radiated from the charcoal-fired chamber; deriving power from the charcoal-fired chamber; and using power derived from the charcoal-fired chamber to control the amount of heat of the cooking region by producing a flow of air communicating with at least one of the cooking region and the charcoal-fired chamber according to a preset temperature. After initial boot up of processor 40, as indicated in step 50, a routine executed by the microprocessor 40 decides in step 52 whether the system resides in a cold start state. If affirmative, the method optionally includes turning on charcoal blower fan 33 as indicated in step 54 and then looping at state 56 until a threshold temperature has been reached. Looping frequency here and elsewhere in the illustrated methods is selected according to the desired response time, and may range from fractions of a second (or millisecond) to several minutes. The threshold temperature is the minimum temperature, say 180° C., to assure reliable power output from converter 44 to operate sensors, fans, and other resources.

After reaching a threshold temperature, the method includes turning off blower fan 33 at step 58 and then entering an operational state that monitors and regulates temperature in cooking region 30. A first process in this operational state includes testing at step 60 whether the internal temperature of cooking region 30 is greater than a setpoint temperature established by thermostat 47. If affirmative, blower fan 33 is turned off and vent fans 32, 34 are turned on at step 62. Thereafter, the method includes looping at step 60 to continue testing the specified condition. When the internal operational temperature of cooking region is not greater than the setpoint temperature, the method includes testing at step 64 whether the internal temperature of cooking region 20 is lower that the setpoint temperature. If negative, the method includes looping back to the test condition of step 60. On the other hand, if the cooking region temperature is lower than the setpoint temperature, the method includes turning off the vent fans 32, 24 at step 66 and then turning on the blower fan 33 at step 68. Turning on blower fan 33 supplies fresh oxygen to the firebox hearth 20, thereby increasing the burn rate of the fuel, which, in turn, increases temperature in cooking region 30. The method includes continuing to loop among the test condition of steps 60, 60, 66, and 68 until another condition is met, e.g., the internal temperature again rises above the setpoint temperature, in which case the routine branches to step 62 to turn off the blower fan 33, and to turn on vent fans 32, 34.

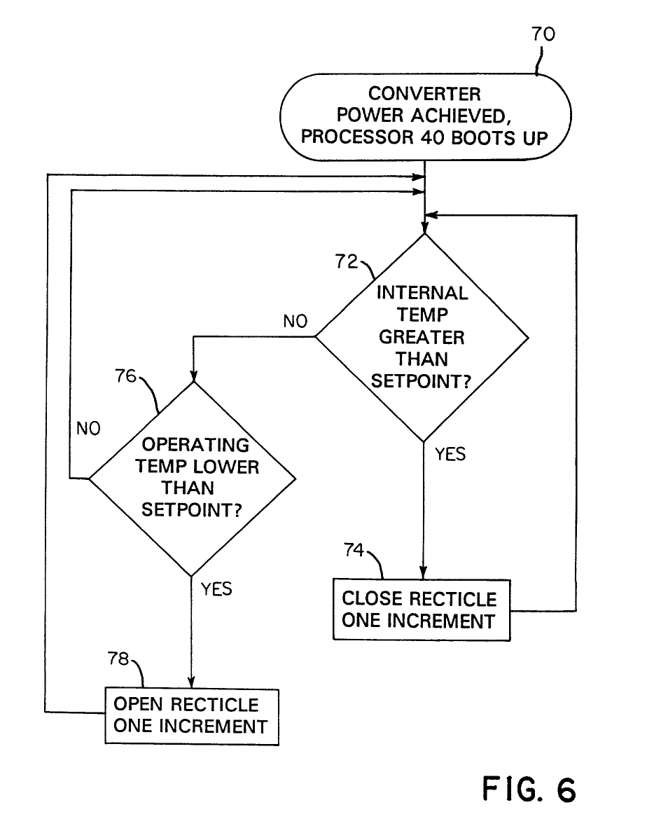

Instead of providing control of temperature by energizing/de-energizing cooling/venting fans, FIG. 6 illustrates a method of controlling internal temperature of cooking region 30 by controlling an incrementally adjustable mechanical shutter that alters the amount of convection heat or radiant energy from the firebox that reaches the cooking region. In FIG. 6, after processor 40 boots up and adequate power is being generated at step 70, the method includes testing whether the internal temperature of cooking region 30 lies above or below a desired set point. Like the method illustrated by FIG. 5, the “mechanical” method of FIG. 6 also includes testing at step 72 whether the temperature in cooking region 30 is lower or higher than a setpoint temperature established by thermostat 47. If affirmative, the method includes closing (e.g., an incremental reduction in the exposure window) at step 74 a variable shutter, which operates similar to a venetian blind, to restrict exposure of radiant energy and/or convention heat from the firebox that reach the cooking region, and then, the process loops back to continue testing at step 72. If during testing at step 72 it is determined that the operating temperature of cooking region 30 is not greater that the setpoint temperature, the process at step 76 is executed to determine whether the set point temperature is lower. If negative, microprocessor 40 again loops back to step 72, and the process is again repeated. On the other hand, if the operating temperature is lower than the setpoint temperature, the mechanically variable shutter is adjusted preferably by opening the mechanical vanes or slitted windows, one increment at a time, until temperature equilibrium is ultimately reached.

FIG. 7 illustrates a control method and apparatus for controlling the amount of radiant energy or convection heat reaching cooking region 30. Firebox hearth 20 containing oxidizing fuel emits radiant energy and convention heat from a facing surface thereof Such radiant energy and convection heat are supplied to cooking region 30 through an incrementally adjustable mechanical shutter assembly located between the firebox hearth 20 and cooking region 30. FIG. 7 shows the shutter assembly spaced away from firebox hearth 20, but in practice, the shutter assembly may be located contiguous to the firebox hearth up to a distance of about one to two centimeters from the face of firebox hearth 20. As illustrated, the shutter assembly comprises panels 80 and 82, each having a series of respective slits or windows 81 and 83 that pass infrared rays, radiant energy, or convention heat from the firebox hearth 20 to the cooking region 30 when aligned with each other. The extent of exposure or the amount of energy allowed to reach cooking region 30 is control by varying the degree of alignment by sliding panel 80 relative to panel 82 in the direction indicated by arrow 85.

One way to achieve alignment control, and thus temperature control, is to provide a temperature responsive element, such as bimetallic element 86 that responds (flexes in the direction of arrow 91) to the temperature in cooking region 30 to increase exposure, i.e., increasing alignment or registration of shutter windows of panels 80, 82 in order to cause an increase in temperature when the temperature inside cooking region is below a setpoint, and to decrease exposure, i.e., by increasing misalignment of shutter windows 81, 83 in panels 80, 82 in order to cause a decrease in temperature when the temperature inside cooking region is above a setpoint. To move the respective panels 80 and 82 into and out of alignment, bimetallic element 86 engages an endpoint 87 of cantilevered arm 88 to move it in a direction indicated by arrow 93. Arm 88 pivots about axis 89 to thus apply a force to panel 82 at an opposite end point 90. A linkage 91 interconnects the arm 88 and panel 82. Adjusting the horizontal position of the base 92 of bimetallic element 86 in a direction indicated by arrow 94 sets an equilibrium point. The position of base 92 is preferably adjusted or calibrated at the factory before shipment. Also, the bi-metallic element may be positioned in the cooking region 30, or between the firebox hearth 20 and shutter assemble 80, 82.

The mechanical shutter may have various forms and structure, the invention not being limited to the structure shown. For example, a “venation blind” or rotary slit-window exposure or other structure may also be used. Also, the temperature-responsive element may have other structures or forms and a bimetallic element may be replaced or substituted with other devices, as known in the art. The shutter assembly may also be arranged as part of cover 22, to drop down in front of the firebox hearth 20. Instead of being controlled by a temperature-responsive element, the shutter assembly may be controlled by an actuator that is controlled by a microprocessor, in much the same way as the various fans are controlled.

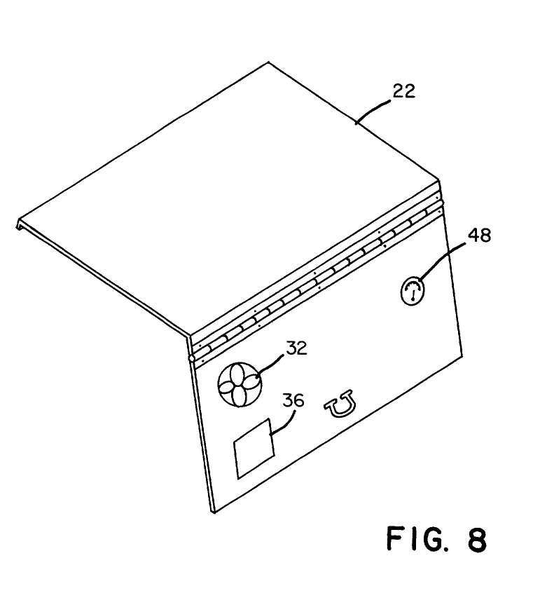

Instead of using the side panel 14 as a host structure, FIG. 8 shows a cover 22 that hosts the module 36, fan 32, and indicator 48 (in the form of a temperature gauge instead of a series of LEDs). Other elements are omitted for the sake of simplicity in illustration, it being understood that location of elements of module 36 is a matter of design choice. Indeed, the module 36 and associated elements may be deployed in the cover or housing of a conventional horizontal barbecue grill. The number of individual components may be altered and their positioning may be arranged to accommodate the structure of the grill in the invention is implemented. As stated above, although a vertical heart barbecue grill is illustrated and described, embodiments of the invention have applicability in conventional horizontal type barbecue grills.

Accordingly, the invention is not limited to the embodiment shown and described but encompasses variations and adaptations as may come to those skilled in the art.

I claim:

1. A temperature-controlled charcoal barbecue grill comprising:
a housing;
a charcoal-fired chamber;
a cooking region;
a cover that substantially encloses the cooking region and the charcoal-fired chamber with the housing; and
a controller responsive to a setpoint and a sensor to control heat in the cooking region by controlling one of airflow with the cooking region and radiant energy from the charcoal-fired chamber that reaches the cooking region.

2. The charcoal barbecue grill as recited in claim 1, wherein the amount heat is controlled by controlling an air path in communication with at least one the charcoal-fired chamber and the cooking region.

3. The charcoal barbecue grill as recited in claim 1, wherein the controller includes an adjustable shutter to control the amount of energy radiated from the charcoal-fired chamber that reaches the cooking region.

4. The charcoal barbecue grill as recited in claim 2, wherein the sensor is selected from a group including a thermocouple, bimetallic element, a temperature probe, an infrared sensor, and a heat sensor, and wherein the sensor detects temperature of one said cooking region and said charcoal-fired chamber.

5. The charcoal barbecue grill as recited in claim 4, further comprising a converter the converts heat emitted from said charcoal-fired chamber to electricity in order to power said controller.

6. The charcoal barbecue grill as recited in claim 5, wherein said converter comprises a thermoelectric converter.

7. The charcoal barbecue grill as recited in claim 2, wherein the controller activates a blower fan that directs air directly upon the charcoal-fired chamber in order to control burn rate of fuel therein.

8. The charcoal barbecue grill as recited in claim 3, wherein the adjustable shutter is adjustable by action of a bimetallic element in order to control temperature in said cooking region.

9. The charcoal barbecue grill as recited in claim 2, wherein said controller comprises a microprocessor.

10. The charcoal barbecue grill as recited in claim 9, further comprising a thermo-electric generator the converts heat energy emitted from the firebox to a useful current that powers the microprocessor.

11. The charcoal barbecue grill as recited in claim 1, further comprising an electrically activated indicator that indicates one of cooking temperature and output energy of the charcoal-fired chamber.

12. The charcoal barbecue grill as recited in claim 11, wherein the indicator comprises at least one of an LED and audible tone generator.

13. A temperature-controlled charcoal barbecue grill comprising:
a housing;
a charcoal-fired chamber;
a cooking region;
a cover that substantially encloses the cooking region and the charcoal-fired chamber with the housing;
a sensor that senses at least one of temperature of the cooking region and energy radiated from the charcoal-fired chamber;
a source of power derived from said charcoal-fired chamber; and
a microprocessor controller responsive to a sensor to control temperature in the cooking region by controlling a flow of air communicating with at least one of the cooking region and the charcoal-fired chamber, the microprocessor controller being powered by said source of power.

14. The temperature-controlled barbecue grill as recited in claim 11, wherein said source of power comprises a thermoelectric converter the converts waste heat from the charcoal-fired chamber to electricity.

15. The temperature-controlled barbecue grill as recited in claim 13, further including at least one blower powered by said source of power to establish said flow of air.

16. The temperature-controlled barbecue grill as recited in claim 13, wherein said source of power comprises a steam-driven mechanism.

17. The temperature-controlled barbecue grill as recited in claim 13, further comprising an electrically activated indicator that indicates one of cooking temperature and output energy of the charcoal-fired chamber, said indicator comprising at least one of an LED and audible tone generator.

18. A method of controlling cooking temperature in a charcoal barbecue grill comprising:
providing a charcoal-fired chamber and a cooking region;
substantially enclosing the cooking region and charcoal-fired chamber within the housing;
sensing at least one of temperature of the cooking region and energy radiated from the charcoal-fired chamber;
deriving power from heat produced by the charcoal-fired chamber; and
using the power to control temperature of the cooking region by producing a flow of air communicating with at least one of the cooking region and the charcoal-fired chamber according to a preset temperature.

19. The method as recited in claim 18, further comprising indicating attainment of a preset temperature of said cooking region.

20. The method as recited in claim 18, further comprising indicating attainment of a preset energy output of said charcoal-fired chamber.

21. A method of controlling cooking temperature in a charcoal barbecue grill comprising:
providing a charcoal-fired chamber and a cooking region;
substantially enclosing the cooking region and charcoal-fired chamber within a housing;
sensing at least one of temperature of the cooking region and energy radiated from the charcoal-fired chamber; and
using sensed heat to control temperature of the cooking region by at least one of controlling a vent and energy radiated from the charcoal-fired chamber reaching the cooking region.

22. The method as recited in claim 21, further comprising providing a bimetallic element to sense heat produced by the charcoal-fired chamber.

23. The method as recited in claim 22, further comprising actuating a shutter using the bimetallic element in order to control radiant energy reaching the cooking region.
